(19) United States
(12) Patent Application Publication
(10) Pub. No.: US 2026/0021617 A1
(43) Pub. Date: Jan. 22, 2026

(54) DEVICE FOR MANUFACTURING A SHEET OR PANEL SHAPED PRODUCT AND METHODS FOR MANUFACTURING A POLYMERIC BOARD OR SHEET MATERIAL AND/OR A DECORATIVE PANEL

(71) Applicant: UNILIN, BV, Wielsbeke (BE)

(72) Inventor: Jonas DEMAN, Wielsbeke (BE)

(21) Appl. No.: 18/998,873

(22) PCT Filed: Jul. 17, 2023
(86) PCT No.: PCT/IB2023/057274

§ 371 Date: Jan. 27, 2025

Related U.S. Application Data
(60) Provisional application No. 63/393,524, filed on Jul. 29, 2022.
(60) Provisional application No. 63/395,498, filed on Aug. 5, 2022.

(51) Int. Cl. B29C 48/00; B29C 48/07; B29C 48/154; B29C 48/40; B29C 48/505; B29C 48/76; B29K 101/12; B29L 31/00

(52) U.S. Cl. CPC B29C 48/0011; B29C 48/002; B29C 48/07; B29C 48/154; B29C 48/509; B29C 48/768; B29C 48/402; B29K 2101/12; B29L 2031/776

(57) ABSTRACT

A device for producing a sheet or panel shaped product includes at least an extruder and a die having a slot opening. A method is provided for producing a polymeric board or sheet material using the device, as well as a method for manufacturing a decorative panel by using the device.

The present invention is directed to a device for manufacturing a sheet or panel shaped product, preferably being a decorative panel or a decorative sheet, e.g. comprising at least a polymeric board or sheet material and an applied theron decoration. The device comprises at least an extruder and a die having a slot opening or a so-called T-die. In another aspect, the present invention pertains to a method for manufacturing a polymeric board or sheet material, preferably a filled solid plastic composite material (SPC), and/or a decorative panel, wherein such a device is applied.

Products, more particularly decorative panels formed as a sheet by an extrusion process are known per se, for example from EP 3 703 926 and EP 3 043 976. The example method of EP'926 includes providing a filler and polymer in powder form, optionally providing additives, such as stabilizers, and heating the obtained mixture until the polymer powder softens to form a kneadable mass and filler powder at least partially bonds thereto. The obtained mass is subjected to cooling; and is subsequently conveyed to an extruder; wherein melting and extruding the mass by means of an extruder happens. The extruder feeds a die, and the sheet is extruded through the opening of the die. The obtained sheet is then pressed to a desired final thickness by means of, for example, calendar rolls. EP'976 discloses a method wherein the obtained sheet is allowed to sag after calendaring in order to reduce residual stresses in the obtained sheet.

EP 3 967 473 discloses a method for applying a decoration in the form of a printed decorative layer onto a polymeric sheet material, and subsequent provision of embossments in an upper surface of the sheet shaped product.

The efficiency and accuracy of the known methods of extrusion, lamination and embossment leaves room for improvement. For example, blisters may form in the calendered sheet, which “blisters” are particularly undesired in view of both mechanical characteristics and aesthetic appearance. The methods of the art require a high maintenance of the rollers, as defects in the roll surface, e.g. pores or cracks, have to be excluded to ensure the best possible quality of products. Furthermore, the thermoplastic materials known as a solid plastic composite or SPC are challenging to extrude, because of the possible high content of fillers, which may be used up to 80 wt. % of the material are particularly challenging in terms of their processibility. Generally, the speed of extrusion of such SPC is notoriously low.

The present invention, in the first place, aims to provide an alternative and/or an improved device for manufacturing a sheet or panel shaped product, said product preferably being a decorative panel and/or a decorative sheet. In accordance with one or more of the preferred embodiments, the present invention provides solutions to one or more problems associated with the devices and/or methods of the state of the art. For example, an alternative or enhanced method for producing a polymeric board or sheet, preferably a highly filled SPC wherein said amount of filler is at least 50 wt. %, preferably at least 65 wt. %, most preferably at least 80 wt. %, is provided.

In a first independent aspect, the present invention pertains to a device for manufacturing a sheet or panel shaped product, said product preferably being a decorative panel or decorative sheet, e.g. comprising at least a polymeric board or sheet material and an applied thereon decoration, wherein said device comprises at least an extruder and a die having a slot opening, said die being coupled to an outlet of the extruder, said extruder and die being configured for extruding a polymeric, preferably thermoplastic, material in an extrusion direction through said slot opening into a polymeric board or sheet material, characterized in that said device has at least one or more of the following characteristics:
the extruder is a parallel twin-screw extruder, a conical twin screw extruder, preferably a super-conical twin-screw extruder, or a multiple-screw extruder;
the device comprises a fume extractor;
the device comprises at least one calendaring roller, wherein the nip between said calendaring roller and a counter roller is adjustable in a direction in the plane perpendicular to the width direction of said slot opening, wherein said direction forms an angle of less than 90° with said extrusion direction;
the device comprises a system of at least five, at least six or at least eight calendaring rollers, preferably arranged to lead to a lamination line wherein at least a decoration in the form of a printed decorative layer is applied to said polymeric board or sheet material;
the device comprises an active delivery system for providing a decorative layer onto the extruded polymeric material;
the device comprises an embossing system for providing embossments in an upper surface of said sheet or panel-shaped product, which embossing system is arranged to operate at temperatures below 95° C., preferably below 70° C.;
the device comprises an embossing system for providing embossments in an upper surface of said sheet or panel-shaped product, which embossing system comprises an embossing roller and a counter roller, wherein the nip between said embossing roller and a counter roller is adjustable in a direction in the plane perpendicular to the width direction of said slot opening, wherein said direction forms an angle of less than 90° with said extrusion direction, preferably wherein said nip is adjustable by means of an actuator; and/or
the device comprises a system for embossing-in-register (EIR), i.e. for providing embossments in an upper surface of said sheet or panel-shaped product in register with a decoration.

Herein, the skilled person understands that a super-conical twin screw extruder, also known as a double conical twin screw extruder, is a conical twin screw extruder wherein the screws are designed so that the outside screw diameter decreases more than the inside screw diameter and thus the passage depth from the filling opening to the screw tip also becomes smaller. This is in contrast to a standard conical twin screw extruder wherein the screws are designed so that the outside and inside screw diameter decrease evenly and the passage depth from the filling opening to the screw tip is constant.

Herein, the skilled person further understands that an active delivery system for providing a decorative layer is a system in which the decorative layer is actively fed or pushed forward, in lieu of being pulled for example of a roll of decorative material, or a system in which the decorative layer is actively tensioned, preferably in a controlled manner. An active delivery system may for example comprise a motorized axle upon which a roll of decorative material is positioned and/or one or more actuators driving the decorative layer, such as a motorized roller and a counter roller with the decorative layer being driven in the nip formed by the roller and counter roller. According to another example an active delivery system may comprise an active tensioning system comprising at least one roller deflecting the decorative layer.

Herein, the skilled person further understands that the extrusion direction is generally perpendicular to the surface defined by said slot opening of the die.

The characteristics of the first independent aspect, each separately, provide for important technical advantages, as explained below. A combination of two or more of the above characteristics may lead to important synergistic effects, as further explained below.

The use of a twin screw extruder may significantly increase the production speed. Preferably a conical twin screw extruder, more particularly a super-conical or double conical twin screw extruder is applied. The twin screw extruder of the conical or super-conical type are of particular interest for the extrusion of polymeric material comprising filler materials, for example at a ratio filler:polymer of over 2:1, or even over 3.5:1. The conical type twin screw extruder may lead to a better uniform dispersion of the filler in the polymer, while maintaining a good extrusion rate and a limited risk of defects, such as screw or bearing breakage. The inventor has noted that the diminishing passage depth towards the exit of the super-conical twin extruder is of particular advantage herein.

An increased rate of extrusion may lead to an increased emission of volatile organic compounds, and the availability of one or more fume extractors along the path of the extruded polymer material may lead to a better management of health hazards during manufacturing. Preferably a fume extractor is positioned in close proximity of said slot opening of the die and/or in close proximity of an embossing roller. At these positions a large amount of emissions are to be expected.

An increased rate of extrusion may also be advantageous for the energy use for providing embossments in an upper surface of said sheet or panel-shaped product. The embossing system may be arranged to operate below 95° C. or 70° C., for example because the to be embossed surface is better maintained at a high temperature after extrusion. Further reference to such embossing may be made below as “cold embossing”.

The adjustability of the nip between a roller, for example a calendaring roller or an embossing roller, and a counter roller leads to a more fluent controlling of the applied pressure, the obtained thickness of the sheet or panel shaped product and/or the quality of the lamination and/or embossment performed with such roller. Using a relatively cold embossing roller may also lead to a better copying of the structure of the embossing roller into the upper surface of said sheet or panel-shaped product.

In a preferred embodiment, the device comprises at least a super-conical twin-screw extruder a system of at least five, or at least six or at least eight, calendaring rollers preferably arranged to lead to a lamination line wherein at least a decoration in the form of a printed decorative layer is applied to said polymeric board or sheet material; and a system for embossing-in-register (EIR) for providing embossments in an upper surface of said sheet or panel-shaped product in register with a decoration, preferably a decoration in the form of a printed decorative layer applied to said polymeric board or sheet material. The increased extrusion rate obtainable by means of said super-conical twin screw extruder is combined with at least five, six or eight calendaring rollers in order to allow for enough time of the product within the calendaring section such that good calendaring is obtained even at the higher speeds, while keeping the necessary pressure and resulting friction on the rollers manageable. Thereby the risk of occurrence of blisters and other unevenesses disturbing the embossing quality is minimized. This is in particular important when an embossing in register is aimed at. Preferably, the system for embossing in register is a cold embossing.

The term “embossing-in-register (EIR)” as used herein, means that the 3-D structure obtained by the embossing process on the upper surface of the decorative panel or the decorative sheet is aligned and/or it corresponds to a printed décoration, which may be a printed decorative film and/or a print provided directly on the polymeric board or sheet material, preferably with the intermediate of preparatory layers, such as grounding or priming layers, and/or a print applied on the underside of the wear layer and/or a printed decorative paper layer and the like. Said embossing is typically done by one or more embossing rollers and may be performed at elevated temperatures, for example at a temperature of at least 95° C., or it can be cold embossing, which means embossing temperature is below 95° C., preferably, below 70° C., more preferably even below 60° C. The embossing roller may be made of steel and/or other thermally conductive material, which is particularly preferred for the hot embossing, or may be made of rubber and the like material, which is suited for the cold embossing process.

An embossing system particularly suited for the device is a cold embossing system, wherein one or more embossing means and/or embossing rollers operate at temperatures below 95° C., preferably below 70° C., more preferably below 60° C. The cold embossing system does not require the heating of the rollers, neither cooling of the embossed product afterwards, which is particularly advantageous with respect to energy saving. Moreover, the structure obtainable by the cold embossing in the device is less prone to unpredictably changing the desired shape of the embossments, as material is less prone to re-flowing into the embossed impressions and/or to building elevated edges around the embossments. Thus, the relief or the 3-D structure obtainable by cold embossing is more stable and of more appealing aesthetics.

In a preferred embodiment, the device comprises a twin-screw extruder. The twin-screw extruder may comprise two parallel or conical correlating and jointly cogging screws and a surrounding housing. Said twin-screw extruders allow for a high pressure build-up and a high feed effect, which can be achieved. The twin-screw extruder is advantageous as the mixing effect of the twin-screw extruder is by far higher than with a single-screw extruder.

In a particularly preferred embodiment, the extruder is a super-conical twin-screw extruder, which allows for mixing in a high amount of additives into a thermoplastic material, especially a high amount of fillers into the thermoplastic material and the extrusion thereof. The super-conical twin-screw extruder is preferred because it is more robust and less prone to breaking. The extrusion on the super-conical twin-screw is faster. Thus, the super-conical twin screw extruder allows for a higher capacity and a more industrial setup, but without compromising on the quality of the extruded material. In particular, said super-conical twin-screw extruder may be preferably equipped with a system for heating and/or cooling, to maintain a desired production speed and a quality of the obtained material. Finally, the device comprising such super-conical twin-screw extruder requires less maintenance or repair.

In one alternative embodiment, the device may comprise a planetary roller extruder with a central spindle and a plurality of planetary spindles surrounding said central spindle. Thereby the raw materials may be supplied via a feed part which is designed as a single-screw extruder. Planetary roller extruder are of particular interest in the cases where degassing of the polymer mixture is desired, for example in cases where slight contaminations are expected. This can be the case when a polymer mixture comprising recycled polymer is being extruded. The planetary roller extruder provides for a larger surface of the polymer, from where contaminations can be sucked off, for example using a vacuum pump.

In one embodiment, the device is arranged so that it can process and/or operate with more than one composition of polymeric, preferably thermoplastic, materials. For example, the device may be arranged for co-extrusion, wherein a polymeric board or sheet material is extruded comprising two or more layers of different composition. In this specific embodiment, preferably more than one extruder is arranged within the device. The extruders may be of the same type, but also may be different with respect to each other. One exemplary embodiment of the device comprises two super-conical twin-screw extruders. In another exemplary embodiment, the device comprises a single screw and a twin-screw extruder. The device may be configured in two possible variations, depending on the point at which the separate melt streams of the material exiting the extruders are brought together. In a first variation, the device allows that the streams are merged into a single laminar melt flow in a feed block, which is positioned immediately upstream of the die and is fed in parallel by both extruders. This embodiment may be suited for the polymer melts of a high viscosity, which viscosity prevents intermingling of the layers as they pass through the die. The flow rate of each component layer can be controlled by valves in the feed block. In a second variation, a die is applied in which separate melt path manifolds are arranged to merge at a point close to the die opening, in order to obtain a co-extruded polymeric board or sheet material leaving the die opening. The thickness and flow rate of individual layers can be independently controlled and it is, in this second variation, also possible to handle polymers with substantially differing viscosities and melt temperatures. In accordance with the second variation the extruders may directly feed the various manifolds of the die, instead of a feed block.

Preferably, the screws of the extruder are ceramic coated screws. Preferably the extruder is a super-conical twin screw extruder equipped with at least two ceramic coated screws. The ceramic coated screws are particularly favored in terms of their performance and robustness.

The device according to the first aspect of the invention is particularly suited for manufacturing a polymeric board or sheet material, wherein a filled thermoplastic material through said slot opening, for example a solid plastic composite material (SPC). Preferably said filled thermoplastic material comprises filler in amount of at least 50 wt. %, more preferably at least 65 wt. %, even more preferably at least 80 wt. %.

In a preferred embodiment, said die is coupled directly to an outlet of said extruder.

In a preferred embodiment, the device comprises a die arranged to allow a necking not larger than 50 mm, preferably not larger than 30 mm. With “necking” the possible constriction of the width of the polymeric material after leaving the die opening is meant. For example a necking of 50 mm with a die opening of 1350 mm, means that the obtained polymeric material has a width of 1300 mm. Preferably, a slack or looseness in the polymeric material as it leaves the die opening and before the calendaring roller is allowed. The inventor notes that such slack or sag minimizes the necking. Preferably, the polymeric material leaves the calendaring rollers with a width greater than the width upon entering the calendaring rollers. In such case the calendaring section may at least partially compensate for necking and make the slab wider again. This can be obtained by setting the nip of the calendaring rollers. The material that is displaced upon setting the thickness in the nip of the calendaring rollers is pushed outwardly to compensate for the necking. So, if in the previous example the thickness of the 1300 mm wide board is reduced by 0.05 mm, 65 mm² of material may be displaced outwardly. If the board has a final thickness of 4 mm, the 65 mm² of material may diminish the necking with 16.25 mm.

The use of twin screw extruders, in accordance with a preferred characteristic of the invention, and in particular super-conical twin screw extruders, may increase the amount of necking due to the high extrusion rates. Providing measures to reduce such necking is hence of particular importance with devices comprising one or more such extruders. Of course, such measures are also of interest with other types of extruders, such as single screw extruders or planetary roller extruders. Therefore, in accordance with a particular independent aspect, the present invention also is a method for manufacturing a sheet or panel shaped product, wherein a polymeric board or sheet material is extruded through a die having a slot opening, and subsequently treated in a calendaring section comprising at least a first calendaring roller and counter roller defining a nip where through the polymeric material is fed, wherein said method shows one or both of the following characteristics:
the characteristic that, after leaving said slot opening and before entering said nip of the first calendaring roller and counter roller, said polymeric material sags out of the plane comprising the width direction of said slot opening and said nip, such preferably under the sole influence of gravity; the sagging at maximum being preferably larger than half the thickness of the polymeric material, or even larger than the thickness of the polymeric material; and/or
the characteristic that said polymeric material leaves the calendaring section with a width greater than the width upon entering the calendaring rollers, preferably said polymeric material leaves said nip defined by said first calendaring roller and counter roller with a width greater than the width upon entering said nip.

It is clear that the present particular independent aspect may apply one or more of the characteristics of the first independent aspect and/or the preferred embodiments thereof, wherein it is possible that a single screw extruder is applied, instead of the preferred twin screw extruders mentioned in the context of the first aspect.

In a preferred embodiment of the invention in accordance with any of its aspects, the device comprises at least said embossing-in-register system, wherein said system is preferably equipped with a camera and/or a marking device and/or is arranged to achieve a precision of at most 2 mm deviation between a decoration and an embossed structure. The marking device may be incorporated in the embossing rollers, e.g. the embossing rollers may comprise additional particular structural features allowing for a fluent camera detection. These features may be positioned to structure an area of the polymeric board or sheet material that is to be removed upon further processing the board or sheet material. Said area may comprise technical markings incorporated in or adjacent to said decoration. The camera may be configured to control the coincidence or distance between the technical markings and the structure provided by said additional particular structural features. For example, a cubic or cylindrical structural feature may be provided on said embossing roller, with the aim of providing a structure coinciding with, respectively, a square or circular technical marking. Said deviation of at most 2 mm between e.g. a printed decoration and the 3-D structure relief provided on the upper surface of a sheet or panel shaped product allows for a decorative panel or decorative sheet material of a nicer appearance and more natural look.

In a preferred embodiment, the device can comprises an additional roller, for example an additional calendaring roller, which may allow providing an additional backing and/or a padding layer on the lowermost surface of the material. This is particularly advantageous in terms of allowing of better acoustic properties, and/or levelling out the underlaying structures.

In a preferred embodiment, the device comprises a cold embossing apparatus arranged to operate at temperatures below 95° C., preferably below 70° C., and an active system for delivering a decorative layer. The cold embossing as well as the active delivery system add to the quality of the obtained embossing, especially in case where an embossing in register is aimed at. The active delivery system allows for a tensionless, near tensionless, or controlled tension provision of the decorative layer unto the extruded polymeric material and subsequent lamination. In such case, the dimension of the decoration can be kept constant or nearly constant, also in between control points or markings. The cold embossing roller delivers high quality embossing, but adjusting the radial position of the embossing roller to keep it in register with the decoration is better avoided. For this reason, the tensionless or controlled tension provision of the decorative layer is beneficial in combination with a cold embossing. Preferably, said apparatus is coupled to said active system for delivering the decorative layer, in the sense that the registration between the embossing roller and the decoration is controlled and adjusted when necessary. Preferably, in such case, it is the tension or stress of the decoration layer that is adjusted to bring it in register with the embossing roller. Thus, preferably, said active system for delivering said decorative layer is preferably equipped with a means for compacting and/or stretching the decorative layer. In that way the size of the decoration can be adjusted to the embossed upper surface, so that good embossing-in-register is maintained. Due to the tensionless, near tensionless, or controlled tension delivery of the decorative layer, adjustments may be minimal.

Preferably, said, preferably cold, embossing apparatus is provided with an embossing roller of a repeat length of more than 2000 mm, preferably of more than 2500 mm, most preferably of about 2690 mm. By such variation in the embossment structure, a more natural appearance of the decorative top layer of the material can be achieved. Preferably said repeat length is used in combination with an active delivery system for the decorative layer. The longer the repeat length is, the more challenging the registration between the embossments and the decoration becomes. An active delivery system is advantageous in that it minimizes required adjustments, as explained above.

In one embodiment, the embossing system comprises an embossing roller and a counter roller, wherein the nip between said embossing roller and said counter roller is adjustable in a direction in the plane perpendicular to the width direction of said slot opening, wherein said direction forms an angle of less than 90° with said extrusion direction. The adjustability in an inclined direction allows for a more accurate adjustment of the size of the nip, especially in cases where the to be embossed surface follows the contour of the embossment roller over a certain angular distance, for example at least over 15°, or at least over 30°, or at least over 60°. The direction in which the embossing roller allows for said adjustment is preferably intersecting with said angular distance, preferably midway or about midway, for example in the middle 25% of the angular length over which the to be embossed surface follows said contour. The inclination may also assist to the embossing process as it partially is supported by the gravity force. Further, such inclination may allow for the easier replacement of the embossing roller.

In a preferred embodiment, an embossing roller is placed to preform the back-embossing, for example, to provide an embossed structure in the side of the material opposite to the side of the upper surface; i.e. to provide the embossments in the side of the polymeric board or sheet material which is oriented towards the underlaying structures whereon said sheet or panel shaped products are to be installed. The back embossing option may be particularly favored for materials wherein a saving in weight or in transportation cost is desired.

Preferably, the device, as well as the methods of the present invention, firstly endless sheets are manufactured, that need to be cut up to the final or nearly final dimensions of the sheet or panel shaped products to be obtained. Preferably, the device is equipped with a guillotine and/or a saw, for example for applications wherein panels or smaller slabs comprising the material for a plurality of panels are desired. The guillotine can be used at higher throughput rates than a saw, and is therefore advantageous in a device comprising a twin screw extruder, in particular a super concial twin screw extruder. The guillotine preferably comprises a knife with a cutting edge that is inclined with respect to the plane of the extruded polymeric material. Such knife gradually cuts the extruded polymeric material upon moving down on it. While cutting the extruded material may be locally obstructed and bulge out in front of the cutting apparatus. In accordance with a special embodiment, a so-called flying guillotine is applied. Such flying guillotine moves synchronously with the extruded material in the extrusion direction while cutting. Bulging out of the extruded material can largely or whole be voided. Such cutting apparatus is particularly favored as it causes less stress and thus less mechanical damage to the material.

In a preferred embodiment, the device is equipped with a cooling system, said cooling system being an air or a water cooling system. Preferably, the cooling system is a water cooling system. In another embodiment, the device may be equipped with an additional heating system, said heating system being preferably an oil or water heating system. Preferably, such cooling and/or heating system is available downstream of the embossing roller and, preferably, upstream of a potential UV lacquering system. A controlled, preferably low, temperature is advantageous to better control the final gloss or mat degree of a top UV cured lacquer.

Preferably, the material is collected on a steel conveyor belt, as such steel conveyor belt leads to less stress of the extruded polymeric material resulting in advanced and improved mechanical characteristics.

In a preferred embodiment, the device has a production capacity of at least about 2.2 ton of material per h, preferably at least 2.5 ton of material per h.

In a second independent aspect, the invention pertains to a device for producing a sheet or panel shaped product, preferably being a decorative panel or decorative sheet, e.g. comprising at least a polymeric board or sheet material and an applied thereon decoration, wherein said device comprises a system of at least five calendaring rollers forming a lamination line, arranged to lead the obtained material to a lamination line or out of the system. The system of at least five calendaring rollers is advantageous for production of e.g decorative panels or decorative sheets, because such calendaring system greatly improves the production efficiency, but also enables to achieve multilayered top layers, such as decorative top layers comprising, for example a printed decorative layer and/or a wear layer and/or a layer present in between said printed decorative layer and the polymeric board or sheet material. The components of such multilayered top layers are more closely bonded to the polymeric board or sheet material and are of increased peeling strength. Moreover, the system of at least five calendering rollers allows for simultaneous lamination of, for example two decorative layers where the upper decorative layer is preferably at least partially translucent of transparent, or two wear layers, wherein a particular decoration or a stronger wear resistance is to be achieved.

The device according to the second independent aspect may have any of the above presented characteristics of the device according to the first aspect.

Preferably, at least the first three rollers are heated, for example, by air and/or water and/or oil, such that the decorative layer, preferably decorative film and wear layer are bonded to the substrate material by heat and pressing. In a preferred embodiment, said lamination of the layers is done exclusively by heat and pressing, preferably without application of glue. Such device setup allows for a production of strong decorative materials, with increased peeling strength and reduced cost, as no glue is to be applied. In an alternative embodiment, said lamination of the layers may be done by applying of a glue.

Preferably, at least the last two rollers of said at least five calendaring rollers are cooled by water and/or air, so when the temperature changes, this will not influence the aesthetic appearance. This is particularly advantageous in producing decorative panels and surfaces which feature embossments or a 3-d structure on the upper surface, so that the high temperatures do not change the embossing design and embossing depth.

Preferably, said system comprises at least six calendaring rollers, wherein the third and fourth rollers are laminating rollers, and are of a greater diametersize with respect to other calendaring rollers in the system. Particularly preferably, said third and fourth calendaring rollers have a diameter of at least 500 mm; preferably about 600 mm or about 700 mm or about 800 mm. It should be understood by a skilled person that any suitably sized calendaring roller may be used without departing from the scope of the invention. The bigger size of said laminating rollers can increase the bonding area between, for example a extruded polymer material and a decorative layer, and/or a wear layer, so that said layers can be more closely adhered together and to said extruded polymeric material, and increase their peel strength.

Preferably, the fifth roller also takes the function of an embossing roller, preferably a rubber roller. Such rubber embossing roller can increase the strength and depth of embossing and make the floor more realistic. Said cold embossing step may be particularly favored as it requires less energy, because it does not require heating of the embossing roller and subsequent cooling. Moreover, said embossing may provide decorative surfaces which are more appealing and/or more in register with the underlaying decorative layer.

In a preferred embodiment, at least one of said at least five calendering rollers shows the characteristic that the nip between said calendaring roller and a counter roller is adjustable in a direction in the plane perpendicular to the width direction of said slot opening, wherein said direction forms an angle of less than 90° with said extrusion direction. The adjustability in an inclined direction allows for a more adequate and even setting of the nip size and for easier maintenance of the system of at least five calendering rollers, for example easier replacement in case of a break-down or a malfunction.

In one preferred embodiment, the system substantially comprises five calendering rollers, preferably forming a lamination and/or embossing line, or being arranged to lead the material to the lamination line.

In another preferred embodiment, the system substantially comprises eight calendering rollers, preferably forming a lamination and/or embossing line, or being arranged to lead the material to the lamination line.

In one embodiment, the calendering machine may be combined with an extruder, for example a single screw extruder and a die, for example a die having a slot opening or a T-die.

In one embodiment, at least three first calendering rollers are chrome coated and mirror polished rollers, equipped preferably with a stainless steel shaft. In such device, a reliable uniformity and mechanical resistance of the produced material is achieved, as well as a high surface quality of the laminated film.

Upon exiting of the section of the device comprising at least five calendering rollers, the possibly laminated extruded polymeric material which is preferably in form of a sheet, may be subjected to further lamination in one or more lamination stations, and/or optional trimming, flatting and/or cutting.

Preferably, a majority of the calendaring rollers is globally positioned with their axes one after the other in the extrusion direction, rather than being globally positioned in a vertical plane.

Preferably, the calendaring rollers are positioned such that the vertical distance between the nip where the extruded polymeric material enters the calendaring section and the nip where the extruded polymeric material leaves the calendaring section is less than two times, or less than one times the diameter of the largest calendaring roller.

Preferably, the calendaring rollers are positioned such that the vertical distance between the nip where the extruded polymeric material enters the calendaring section and the nip where the extruded polymeric material leaves the calendaring section is less than the horizontal distance between these nips.

Preferably, one or more of the calendaring rollers also functions as a laminating roller for providing a decorative layer and/or a wear layer unto the extruded polymeric material. Preferably, one or more of the calendaring rollers also functions as an embossing roller.

Preferably, said device further comprises a heating module and/or a water cooler, which is advantageous for producing materials wherein the precise temperature control of the roller is desired or necessary.

Preferably, said device is fully automated and controllable by means of a computer system, optionally cloud based operations. By such setup, said computer and/or cloud system allows for a fine tuning and adjustment of the parameters of the device.

The devices according to a first and a second aspect are suited for manufacturing a polymeric board or sheet material, said material preferably being a filled thermoplastic material, more preferably a decorative panel and/or sheet material comprising at least a polymeric board or sheet material and an applied thereon decoration, which method constitutes an independent third aspect of the present invention.

Preferably, the device according to a first or a second aspect and a method according to the third aspect are particularly suitable or applied for provision of the materials used as a decorative cover materials, for example floor, wall or furniture coverings.

Said materials preferably comprise a top layer having a decoration. The top layer may be a single layer or be composed of multiple sheets and a polymeric board or sheet material located underneath said decoration or top layer.

Preferably, the extruded polymeric material as mentioned in the preceding aspects is filled thermoplastic material, which may be a rigid thermoplastic material. The thermoplastic material preferably comprises one or more of the following thermoplastic synthetic materials: PVC (polyvinyl chloride), polyethylene, HDPE (high density polyethylene), polypropylene, polyester, polyethylene terephthalate (abbreviated PET), polyurethane and/or elastomer. The most preferred synthetic material is PVC.

The rigidity of the thermoplastic material, in particular PVC, can be optimized by using an appropriate amount of plasticizer or no plasticizers at all. If plasticizers are used, this preferably is in an amount of less than 15 phr, less than 10 phr or less than 5 phr. It is noted that an amount of plasticizers of less than 15 phr means that per 100 parts of thermoplastic synthetic material less than 15 parts of plasticizers are present. Examples of plasticizers which can be applied are phthalate-based plasticizers, such as di-isononyl phthalate, abbreviated DINP, or di-octyl phthalate, abbreviated DOP or DNOP, or, as an alternative for phthalate-based plasticizers, di-octyl terephthalate, abbreviated DOTP, or di-isononyl-1, 2-cyclohexane dicarboxylate, abbreviated DINCH.

The extruded polymeric material preferably comprises fillers. Fillers promote the stiffness of the panels. Various kinds of fillers may be applied, whether or not in combination:
an inorganic filler, such as chalk, lime and/or talc;
an organic filler, such as wood, bamboo and/or cork; and/or
a mineral filler.

It is also noted that the filler talc is particularly advantageous. Namely, it has shown that this filler has a positive effect on the dimensional stability of the material, especially if said material is to be used for producing a decorative panel or a decorative sheet.

The percentage of filler preferably is situated between 30 and 90 wt. % of the material, preferably between 45 and 75 wt. % of the material. Preferably, the material obtainable by the method comprises at least 50 wt. % of a filler, preferably at least 65 wt. % of a filler. Herein, it is noted that the percentage by weight is considered in respect to the total weight of the material.

The proportion of filler preferably is at least 40 percent by weight, more preferably at least 50 percent by weight and still more preferably at least 60 or at least 70 percent by weight. Said high proportion of filler increases the dimensional stability of the material, especially if said material is to be used as a substrate for a decorative panel or a decorative sheet.

The thermoplastic material may comprise an impact modifier, a stabilizer, such as a Ca/Zn stabilizer, and/or a color pigment, such as carbon black.

It is also noted that the material may or may not comprise or be recycled material.

Preferably, said material is not or almost not foamed. The non-foamed material does not only offer a better resistance against telegraphy effects than foamed layers, but also against indentation. It is also noted that almost not foamed means that the density of the unfoamed material by foaming is not reduced or reduced by maximum 10% and preferably by maximum 5% or by maximum 2%. The density of the not or almost not foamed material preferably is situated between 1300 and 2000 kg per cubic meter or between 1500 and 2000 kg per cubic meter.

However, it is not excluded that the material is foamed. In fact, the inventor has found that foaming has a positive influence on the dimensional stability. Preferably, the density reduction is more than 10%. This means that the density of the unfoamed thermoplastic material is reduced by more than 10% by foaming.

With the intention of better showing the characteristics according to the invention, in the following, as an example without limitative character, some embodiments are described, with reference to the accompanying drawings, wherein:

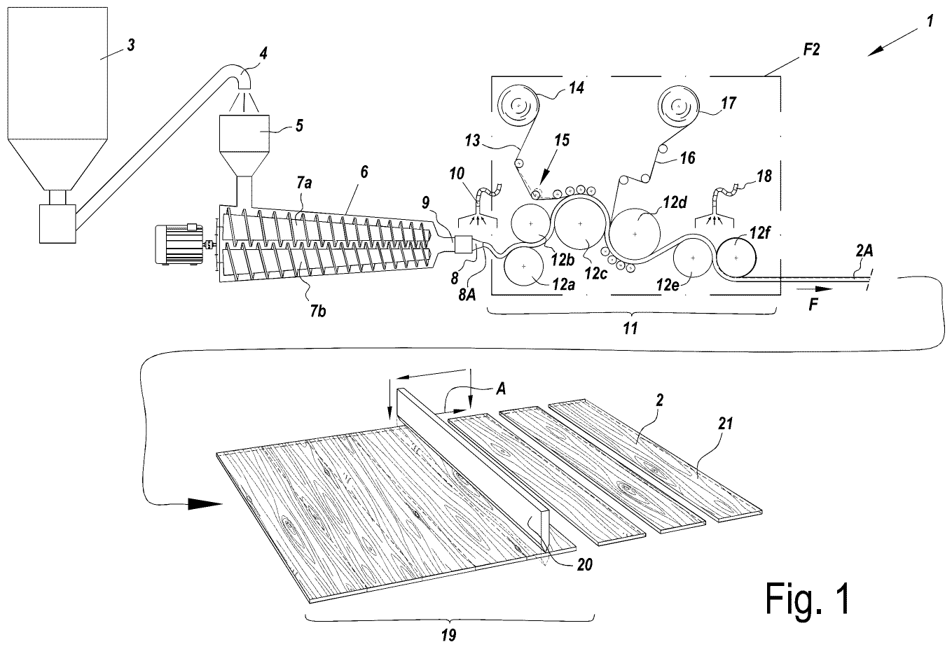

FIG. 1 shows schematically a device 1 for manufacturing a sheet or panel shaped product according to the first aspect;

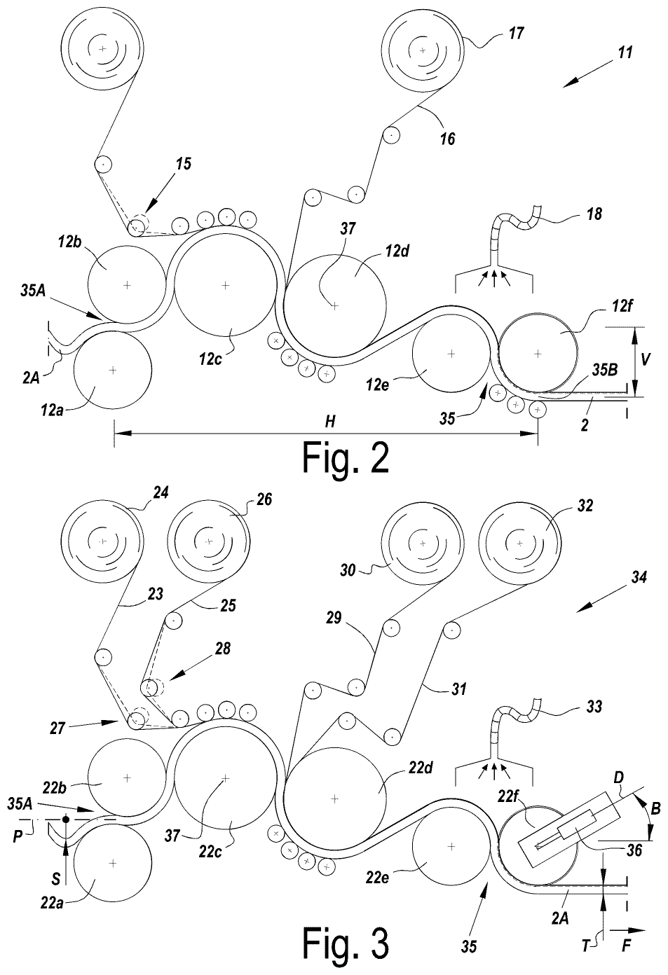

FIG. 2 at a larger scale shows the section indicated with F2 in FIG. 1; and

FIG. 3 in a same view as FIG. 2 represents a variant.

FIG. 1 shows a device 1 for manufacturing a panel shaped product 2. The mixing tank 3 of the device 1 comprises a mixture of thermoplastic material and additives, which are guided by a piping system 4 to the feed 5 of the super-conical twin-screw extruder 6. The screws 7a, 7b are ceramic coated. The die 8 is coupled directly to an outlet 9 of the extruder 6. The device for fume extraction 10 is arranged to collect any fumes at the point where the extruded material leaves the die 8, i.e. at the slot opening 8A of the die 8, and is guided towards a six roll calendering system 11, which is shown enlarged also in FIG. 2.

In said six roll calendering system 11, the extruded polymeric material 2A is guided through the first four rolls 12a, 12b, 12c, 12d, which first four rolls 12a, 12b, 12c, 12d are heated. The decorative film layer 13 in the form of a printed film is provided by a separate means 14 and laminated and/or calendered to the extruded polymeric material 2A. The device 1 preferably has an active system 15 for adjusting of the size of said decorative film layer 13 and/or better fitting onto the extruded polymeric material 2A. The wear layer 16 is provided from a separate roll 17 and laminated and/or calendered onto said decorative film 13 by the calendering rollers 12c, 12d. The extruded polymeric material 2A is then further guided to a fifth and sixth calendering roller 12 e, 12 f, which rollers operate at relatively lower temperatures than the rollers 12a, 12b, 12c, 12d. The sixth calendering roller 12f also functions as an embossing roller suited for cold embossing. An additional device for fume extraction 18 is placed at this point. The thus laminated and embossed extruded polymeric material 2A is further guided in the extrusion direction F towards the cutting section 19 wherein said material is being cut by a flying guillotine 20 into planks 21. The arrows A illustrate that the guillotine 20 moves in the extrusion direction F while cutting.

FIG. 2 clearly shows a six roller calendering system 11, which is arranged to take over an extruded polymeric material 2A and which allows for applying a decorative film layer 13 and a wear layer 14 thereon.

FIG. 3 shows an exemplary, preferred embodiment of the device 34 according to the second aspect, which may or may not be coupled to an extruder section, but in this case is coupled to a similar extrusion section as represented in FIG. 1. The device 34 comprises at least a six roller calendering system, wherein said six rollers 22a, 22b, 22c, 22d, 22e, 22f are arranged in substantially the same way as already described in the system shown in FIG. 1. Said six rollers 22a, 22b, 22c, 22d, 22e, 22f allow for an application of a décor film 23 provided from a roll 24 and another décor film 25 provided from another roll 26 said décor films 23, 25 being adjusted to each other and to the underlaying material by an active tensioning system 27 adjusting the size of the decor film 23 and a second active tensioning system 28, for adjusting the size of the second décor film 25. In this case the active tensioning system 27 comprises a roller deflecting the decorative film 23, until the desired tension is obtained. The device 34 also further comprises a roll 30 for providing the first wear layer 29 and an additional roll 32 for providing a second wear layer 31. The calendering rollers 22e, 22f operate at lower temperatures and are coupled to a device for fume extraction 33. The roller 22f is preferably a rubber roller suited for cold-embossing, preferably in register with the decoration of the extruded polymeric material 2A.

FIG. 3 also shows that the nip 35 between the embossing roller 22f and the counter roller, i.e. the calendaring roller 22e, may be adjustable in a direction D in the plane perpendicular to the width direction of said slot opening 8A, i.e. in the plane of FIG. 3. Said direction D forms an angle B with the extrusion direction F of less than 90°, in this case the angle B is about 30°. The nip 35 may be adjusted by means of the actuator 36 shown in the figure.

In the figures, a majority of the calendaring rollers 12a-f; 22a-f is globally positioned with their axes 37 one after the other in the extrusion direction F, rather than being globally positioned in a vertical plane. The calendaring rollers 12-22 are positioned such that the vertical distance V between the nip 35A where the extruded polymeric material 2A enters the calendaring section and the nip 35B where the extruded polymeric material 2A leaves the calendaring section is less than two times, or less than one times the diameter of the largest calendaring roller 12c-22c. This vertical distance V is less than the horizontal distance H between these nips 35A-35B. Herein the distance V is measured between the centers of the respective nips 35A-35B. For the horizontal distance H the location of the narrowest region in the nip 35A-35B is considered.

The figures further illustrate that the extruded polymeric material 2A after leaving said slot opening 8A and before entering the nip 35A of the first calendaring roller 22a and counter roller, here the second calendaring roller 22b, said polymeric material 2A sags out of the plane P comprising the width direction of said slot opening 8A and said nip 35A, such preferably under the sole influence of gravity; the sagging S is at maximum larger than half the thickness T of the extruded polymeric material 2A, or, in this case, even larger than the thickness T of the extruded polymeric material 2A.

The present invention is not limited to the preferred embodiments described here above, but such devices and methods may be realized according to several variants without leaving the scope of the invention.

1.-16. (canceled)

17. A method for manufacturing a decorative panel comprising at least a polymeric board and an applied thereon decoration,
wherein said polymeric board is a filled solid plastic composite material having an amount of filler of at least 50 wt %,
wherein said method comprises
using a device comprising at least an extruder and a die having a slot opening, said die being coupled to an outlet of the extruder, said extruder and die extruding polymeric material in an extrusion direction through said slot opening into said polymeric board,
wherein said extruder is a parallel twin-screw extruder, a conical twin-screw extruder or a super-conical twin-screw extruder.

18. The method of claim 17, wherein said device has at least one or more of the following characteristics:
the device comprises a fume extractor;
the device comprises at least one calendaring roller, wherein the nip between said calendaring roller and a counter roller is adjustable in a direction in the plane perpendicular to the width direction of said slot opening,
wherein said direction forms an angle of less than 90° with said extrusion direction;
the device comprises a system of at least five calendaring rollers, forming a lamination line or arranged to lead to a lamination line wherein at least a decoration in the form of a printed decorative layer is applied to said polymeric board or sheet material;
the device comprises an active delivery system for providing a decorative layer onto the extruded polymeric material;
the device comprises an embossing system for providing embossments in an upper surface of said sheet or panel-shaped product, which embossing system is arranged to operate at temperatures below 95° C.;
the device comprises an embossing system for providing embossments in an upper surface of said sheet or panel-shaped product, which embossing system comprises an embossing roller and a counter roller,
wherein the nip between said embossing roller and a counter roller is adjustable in a direction in the plane perpendicular to the width direction of said slot opening,
wherein said direction forms an angle of less than 90° with said extrusion direction, wherein said nip is adjustable by means of an actuator; and/or
the device comprises a system for embossing-in-register (EIR), i.e. for providing embossments in an upper surface of said sheet or panel-shaped product in register with a decoration.

19. The method of claim 17, wherein
the extruder is a super-conical twin-screw extruder;
the device comprises a system of at least five calendaring rollers, forming a lamination line or arranged to lead to a lamination line wherein at least a decoration in the form of a printed decorative layer is applied to said polymeric board or sheet material; and
the device comprises a system for embossing-in-register (EIR) for providing embossments in an upper surface of said sheet or panel-shaped product in register with said decoration.

20. The method of claim 17, wherein said die is arranged to allow a necking not larger than 50 mm.

21. The method of claim 17, wherein said extruder is a super-conical twin screw extruder equipped with at least two ceramic coated screws.

22. The method of claim 17, wherein said device comprises at least said embossing-in-register system,
wherein said system is equipped by a camera and/or a marking device and/or
wherein said system is arranged to achieve a precision of at most 2 mm deviation between a decoration and an embossment.

23. The method of claim 17, wherein said device further comprises an additional calendaring roller for provision of a backing and/or a padding layer.

24. The method of claim 17, wherein said device comprises an embossing system for providing embossments on an upper surface of said sheet or panel-shaped product, which embossing system is arranged to operate at temperatures below 95° C., and
wherein said device comprises an active delivery system for providing a decorative layer onto the extruded polymeric material,
wherein said embossing system is coupled to said active delivery system.

25. The method of claim 24, wherein said embossing system is provided with an embossing roller of a repeat length of more than 2000 mm.

26. The method of claim 17, wherein said device is equipped with a cooling system, said cooling system being an air or a water-cooling system.

27. The method of claim 17, wherein said device has a production capacity of at least about 2.2 tons of material per hour.

28. The method of claim 17, wherein said polymeric board comprises at least 65 wt. % of a filler.

29. The method of claim 17, wherein said polymeric board is extruded through a die having a slot opening and subsequently treated in a calendaring section comprising at least a first calendaring roller and counter roller defining a nip where through the polymeric material is fed,
wherein, after leaving said slot opening and before entering said nip of the first calendaring roller and counter roller, said polymeric material sags out of the plane (P) comprising the width direction of said slot opening and said nip, such as under the sole influence of gravity; the sagging (S) at maximum being larger than half the thickness (T) of the polymeric material, or even larger than the thickness (T) of the polymeric material.

30. The method of claim 17, wherein said polymeric board is extruded through a die having a slot opening, and subsequently treated in a calendaring section comprising at least a first calendaring roller and counter roller defining a nip where through the polymeric material is fed,
wherein, said polymeric material leaves the calendaring section with a width greater than the width upon entering the calendaring rollers, said polymeric material leaves said nip defined by said first calendaring roller and counter roller with a width greater than the width upon entering said nip.
